(19) United States
(12) Patent Application Publication
(10) Pub. No.: US 2005/0186017 A1
(43) Pub. Date: Aug. 25, 2005

(54) Microprint pen

(76) Inventor: Aaron S. Brandstein, Bronx, NY (US)

Correspondence Address: LACKENBACH SIEGEL LLP, One Chase Rd., Scardale, NY, 10583, US

(21) Appl. No.: 11/062,191

(22) Filed: Feb. 18, 2005

Related U.S. Application Data
(60) Provisional application No. 60/545,982, filed on Feb. 19, 2004.

(51) Int. Cl. B43K 7/00; B43K 7/03

(52) U.S. Cl. 401/215; 401/209

(57) ABSTRACT

A writing instrument for creating a unique marking and method of using the same is provided. The writing instrument has a casing having a working end and a non-working end; an ink source situated in said casing; and a point having microprinting means disposed on an outer surface thereof for depositing a line having a microprint embedded code formed by said microprinting means, said point being disposed at the working end of the casing, said point being a movable member arranged to rotate when moved along a surface, and said point being in fluid flow communication with said ink source.

### PRIORITY INFORMATION

This utility patent application claims priority from U.S. Provisional Application No. 60/545,982 filed on Feb. 19, 2004.

### BACKGROUND OF THE INVENTION

1. Field of the Invention

The present invention relates generally to writing instruments and more specifically it relates to a writing instrument for creating unique markings or microprints within a written ink line, thereby providing means for verification of document authorship, origin and/or content authenticity.

2. Description of the Related Art

It can be appreciated that writing instruments such as pens have been in use for centuries. Typically, pens are used to write and/or sign documents such as contracts, currency, bonds, stocks, securities, travelers checks, bank checks, credit cards, credit cards receipts, passports, airline tickets, labels, green cards, prescription slips, tests and examinations, police or witness reports, affidavits, research documents, legal waivers and releases, and any other business, personal, legal and/or government documents in which identification of the creator or signatory is critical. Pens may also be used in many unofficial applications, including but not limited to personal correspondence, journaling for posterity, archiving and scrap-booking, writing for publication, autographing, or a variety of other unofficial purposes.

Writing implements known in the art are limited in that they do not provide means for identifying writing as being unique to a particular writing implement for the purposes of security or verification of authorship, origin and/or content authenticity. Reliance on handwriting analysis has been the sole basis for establishing authenticity. Thus, conventional pens do not offer any security features and it is possible to forge or otherwise deceitfully obscure the origin, authorship and/or content authenticity of writings by simply mimicking the signature or writing of another individual.

While conventional writing instruments such as pens are suitable for writing and creating a mark, they fail to provide means of verification of document authorship, origin and/or content authenticity on the basis of the instrument used. The writing instrument of the present invention substantially improves upon the designs of the prior art by providing a writing instrument that creates a unique marking or microprint within a printed or written ink line, thereby providing means of verification of document authorship, origin and/or content authenticity.

### SUMMARY OF THE INVENTION

In view of the foregoing disadvantages inherent in writing implements of the prior art, the present invention provides a new microprint pen construction wherein the same can be utilized for creating unique markings, or microprint, within the written or printed ink line(s) to provide means of verification of document authorship, origin and/or content authenticity of all lines or markings created by the pen, including all content in addition to the signature.

The general purpose of the present invention, which will be described subsequently in greater detail, is to provide a writing instrument resulting in a new microprint pen with an inherent security function which is not anticipated, rendered obvious, suggested, or even implied by any of the prior art writing instruments, either alone or in any combination thereof.

A primary object of the present invention is to provide a microprint pen that will overcome the shortcomings of the prior art devices.

An object of the present invention is to provide a pen for creating unique microprint markings within the written ink line(s) to provide means of verification of document authorship, origin and/or content authenticity, including all content in addition to the signature.

Another object is to provide a microprint pen that provides a unique result that is unobtrusive and does not limit or interfere with normal use of the writing apparatus.

Another object is to provide a microprint pen that provides a unique result that may not be noticed without special attention or knowledge of its presence.

Another object is to provide a microprint pen that provides a unique result without any special effort or training of the creator or writer.

Another object is to provide a microprint pen that provides a unique result that may not be copied or reproduced by conventional means.

Another object is to provide a microprint pen that may be utilized for various levels of security and in multiple circumstances.

Another object is to provide the option of a self-contained verification system in the form of an included magnifying device in the cap of the microprint pen to examine microprint within the written line(s) and check code authenticity and/or clarity.

These objects are achieved by a writing instrument for creating a unique marking having a casing, having a working end and a non-working end; an ink source situated in said casing; and a point having microprinting means disposed on an outer surface thereof for depositing a line or character having a microprint embedded code formed by said microprinting means, said point being disposed at the working end of the casing, said point being a movable member arranged to rotate when moved along a surface, and said point being in fluid flow communication with said ink source.

The objects are additionally achieved by a method of making a microprinted line comprising the steps of: employing a writing instrument comprising a casing having a working end and a non-working end; an ink source situated in the casing; and a point disposed at the working end of the casing and mounted for rotation when moved along a surface, said point having microprinting means disposed thereon, wherein said point communicates with said ink source and a writing surface; moving said point of said writing instrument across said writing surface such that said point rotates along said surface; and depositing a written line on said writing surface that incorporates microprint embedded code formed by said microprinting means.

The objects are further achieved by a method for authenticating a written ink line as being unique to a particular writing instrument, the method requiring the steps of assigning a writing implement comprising a casing having a working end and a non-working end; an ink source situated in casing; and a point disposed at the working end of the casing, said point having a unique microprinting means disposed thereon to a specific creator; having said creator employ said writing implement for writing, thereby creating a writing having a microprinted code formed therein; inspecting said writing for said microprinted code formed by said microprinting means; and ensuring that said microprinted code formed by said microprinting means matches said microprinting means of said assigned writing implement.

Other objects and advantages of the present invention will become obvious to the reader and it is intended that these objects and advantages are within the scope of the present invention.

### BRIEF DESCRIPTION OF THE DRAWINGS

Various other objects, features and attendant advantages of the present invention will become fully appreciated as the same becomes better understood when considered in conjunction with the accompanying graphics, in which like reference characters designate the same or similar parts throughout the graphic, and wherein:

FIG. 1 is a perspective view of a first embodiment of the microprint pen of the present invention.

FIG. 2 is a magnified perspective view of the tip of the microprint pen shown in FIG. 1.

FIG. 3 is a magnified view of the point of the microprint pen shown in FIG. 1.

FIG. 4 is a magnified perspective view of the point of the microprint pen shown in FIG. 1, shown in cross-section to illustrate depth.

FIG. 5 is a magnified perspective view of a layered point of the microprint pen shown in FIG. 1 shown in cross-section to illustrate depth.

FIG. 6 is a perspective view of an alternate embodiment of the microprint pen of the present invention having a non-spherical point.

FIG. 7 is a magnified perspective view of the point of the microprint pen of the present invention having a non-spherical point shown in window A of FIG. 6.

FIG. 8 is a magnified front view of the tip of the microprint pen of the present invention shown in window A of FIG. 6.

FIG. 9 is a cross-sectioned side view of the ink reservoir of the microprint pen of the present invention shown in FIG. 1.

FIG. 10 is a side view of the magnifying pen cap for any embodiment of the microprint pen of the present invention.

FIG. 11 is a side perspective view illustrating the pen cap of the microprint pen of the present invention illustrating the microprint feature within the written ink line magnified using the magnification feature of the pen cap.

FIG. 12 is a side perspective view of the magnifying pen cap of the microprint pen of the present invention in use with a doctor's prescription pad.

### DETAILED DESCRIPTION OF THE INVENTION

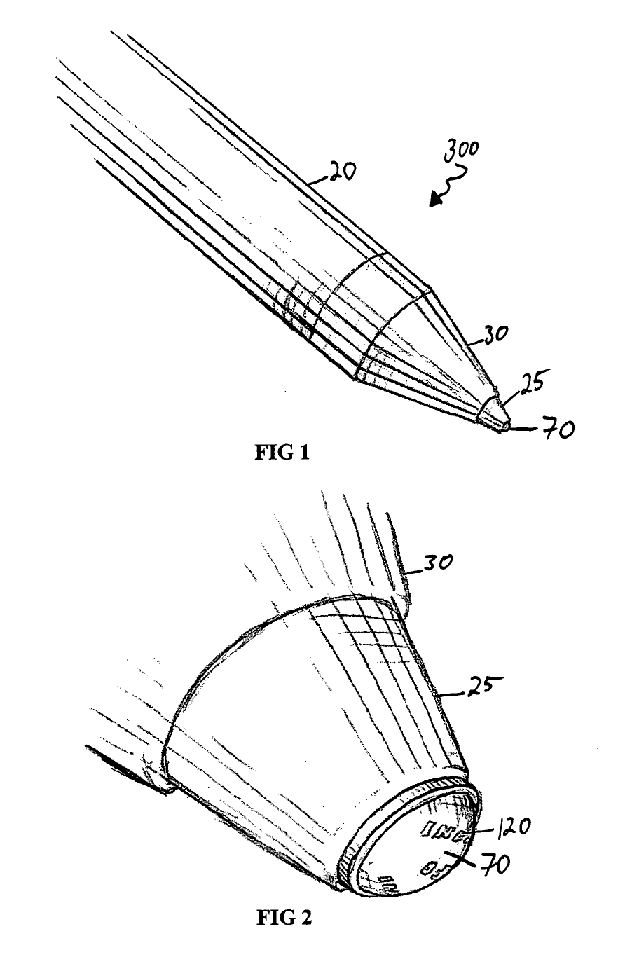

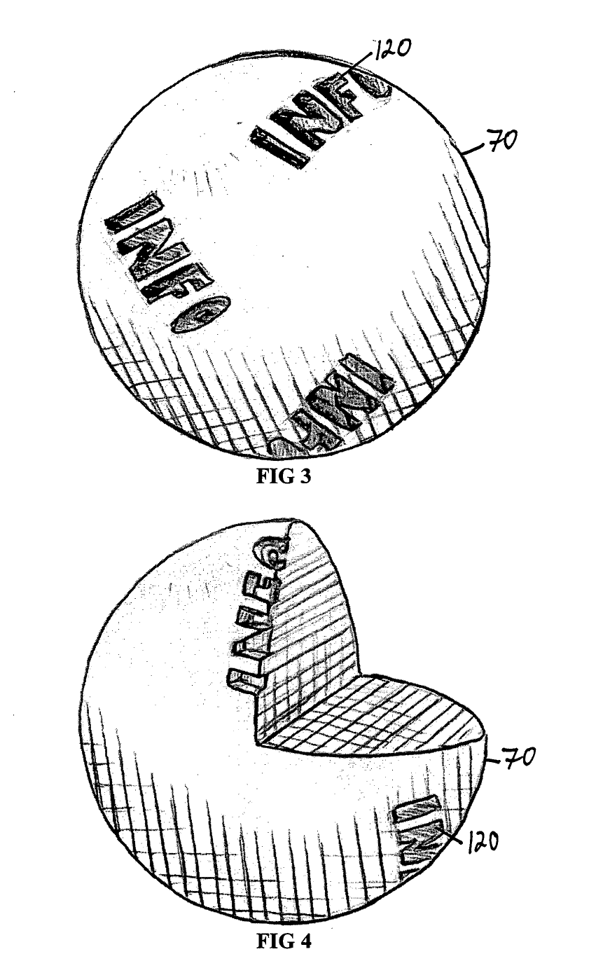

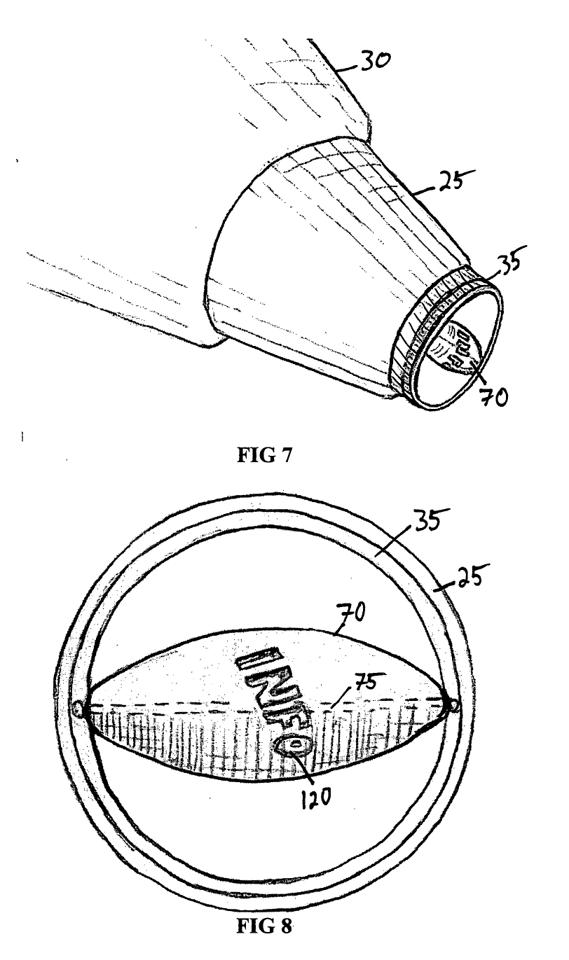

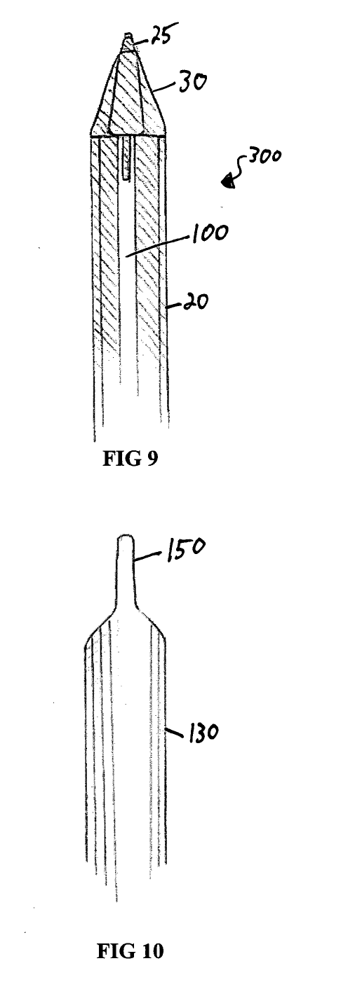

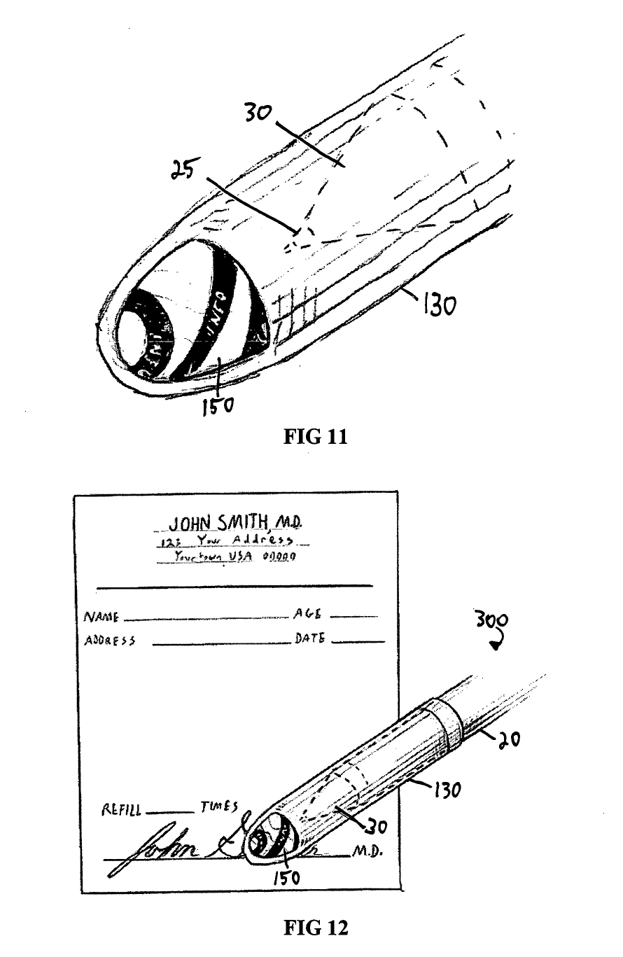

A microprint pen 300 is illustrated in FIGS. 1 to 12, in which similar reference characters denote similar elements throughout. Microprint pen 300, as illustrated in FIG. 1, has a casing 20, a tip 30, a stem 25, and a point 70. As illustrated in FIG. 2, point 70 is housed within stem 25. Stem 25 is housed within tip 30. Stem 25 regulates the ink flow between the reservoir and the point. Casing 20 preferably has a reservoir or source of ink 100, as illustrated in FIG. 9. Tip 30 is removably coupled by any suitable means to the working end casing 20. Point 70 allows appropriate access to ink reservoir or source 100 through stem 25. As shown in FIG. 3, point 70 is preferably spherical, having unique microprint features 120 that are permanently formed on the surface of point 70. Microprint features 120 may be raised or recessed or both simultaneously. Point 70 is designed to deliver ink directly onto a writing surface. Casing 20, tip 30, stem 25, and point 70 may vary considerably in color, size, shape, volume, weight, density, and material. Tip 30 and/or stem 25 may also be integrally formed with ink reservoir or source 100. Microprint pen 300 may further have a cap 130 for protecting tip 30, as illustrated in FIG. 11.

Referring again to FIG. 1, casing 20, is preferably thin and tubular, such that it may be easily gripped and manipulated by hand for the purpose of creating controlled markings on a writing surface. Tip 30 is preferably conical in shape. Tip 30 houses the stem 25 that houses point 70 in such a way as to allow limited access to ink reservoir or source 100, while also allowing point 70 to protrude appropriately to make direct contact with a writing surface. Tip 30 may be coupled to casing 20 by a variety of means, including but not limited to screwing onto threads cut into the working end of casing 20, snapping into place, fitting into or onto casing 20 by means of friction or vacuum or suction pressure (whereby pressure inside the casing is significantly lower than atmospheric pressure outside the casing, allowing this acting force to hold parts of the casing together as one unit) or being fitted and secured by means of an adhesive, or otherwise fastened in such a way as to be secure for use while allowing necessary access, opening, detaching, or disassembling of components for the purposes of refilling, emptying, cleaning, or any other action needed for use or maintenance. It should be noted that tip 30 and casing 20 may comprise one integral piece, as in a disposable embodiment of the present invention.

Casing 20 has an opening for the insertion, removal, and replacement of ink reservoir or source 100. Ink reservoir 100 preferably has openings, where necessary, to allow air to enter and, thus, ink to escape. Alternatively, ink reservoir 100 may be pressurized, thereby averting the need for an opening.

Ink reservoir or source 100 (if a separate reservoir or other component is employed) is inserted into casing 20, by means of an opening located in one end of casing 20, or alternately by means of separating a first half of casing 20 from a second half of casing 20 and reattaching the halves around ink reservoir or source 100 by any of a number of secure and removable means as described above. Tip 30 is coupled to the working end of casing 20 by any of a number of secure and removable means as described above. Ink reservoir 100 may alternately be inserted and attached by screwing means, if ink reservoir 100 and tip 30 are designed as separate components and may therefore be disengaged from one another without damaging or otherwise hindering the functioning of microprint pen 300. Alternatively, ink reservoir 100, casing 20, tip 30, stem 25 and point 70 in any combination may also be formed as one integral unit such that any attempt to insert ink or replace ink reservoir 100 would render microprint pen 300 inoperable, thus limiting the use of that specific microprint pen 300 by rationing the initial load of ink to an amount suitable for a limited number of uses.

In an alternate embodiment, ink reservoir 100 is pressurized or specially designed to preclude the need for an air hole in casing 20 to allow delivery of ink. In an additional embodiment not shown, ink may be deposited directly into an opening in casing 20. Microprint pen 300 may employ additional alternate ink sources. Non-limiting examples of such ink sources include, but are not limited to a liquid reservoir, a sponge, and powdered or solid color sources. Casing 20 may also be designed to hold and dispense ink without need for a separate ink reservoir 100. Microprint pen 300 may additionally be designed to allow the insertion, attachment, or use of tip 30, or wherein tip 30 and stem 25 is inextricably a part of ink reservoir or source 100.

Microprint pen 300 may have a spring loaded mechanism for the engagement and disengagement of stem 25 that selectively causes stem 25 to be moved between a retracted position wherein it is concealed within tip 30 and an extended position, as illustrated in FIG. 1. Alternately, microprint pen 300 may have a rotating tip mechanism for retracting stem 25. Retracting and rotating tip mechanisms are well known in the art.

Microprint pen 300 may be designed to allow for the use of a variety of covers or caps 130, which may fit over the non-working end of casing 20. Cap 130 may have features, including but not limited to a discerning or decoding means 150 for the examination of microprint in a marking made using microprint pen 300. Discerning or decoding means 150 may be a magnifying means, UV means, or other means for revealing microprint coding in a marking made using microprint pen 300.

Referring to FIGS. 3 through 5, point 70 is preferably spherical. Microprint features 120 are disposed on the surface of point 70. Microprint features 120 may be engraved into the surface of point 70, as shown in FIG. 3. Alternately, as shown in FIG. 5, microprint features 120 may be layered onto point 70 or raised above the surface of point 70 (not shown). Microprint feature 120 may simply be in the form of a magnetic pattern with no other special qualities. The point may be manufactured as one solid unit of all the same material or a mixture of materials FIG. 3, or may be comprised of multiple layers of different materials FIG. 5. or multiple layers of the same material FIG. 5. Microprint features 120 may be symbols, numbers, letters, or any other recognizable characters or images, and may utilize ultra-violet, magnetism, or physical indentation to create said markings. Point 70 is housed in the end of stem 25 in such a way as to enable appropriate access to ink reservoir or source 100 while also protruding appropriately from stem 25 in such a way as to remain secure while making contact with a writing surface. In use, point 70 is in direct contact with the document or writing surface. As point 70 is drawn along the surface, ink is drawn onto point 70 from ink reservoir 100 and is transferred onto a writing surface, leaving a written ink line. Within the written ink line, point 70 also leaves a negative or positive, ultra-violet, or magnetic image of the symbols, numbers, letters, or any other recognizable characters, images or markings engraved into, protruding from, or magnetically or chemically printed on point 70. The markings may appear in the form of magnetic differences in the ink pattern of the written line. The markings may or may not be visible to the naked eye, ultraviolet or other light-dependent markings that may or may not be visible to the naked eye, or physical indentations that may or may not be visible to the naked eye. The markings may include a time-sensitive factor, such as but not limited to an encoded date or magnetized ink that's magnetic field weakens as time passes, thus limiting the period of time in which that particular microprint pen may be considered valid and providing additional security.

Point 70 may be a ball bearing, such as those found in conventional ballpoint pens, with the unique feature of being engraved with microprint features 120. Point 70 may also be a differently shaped piece that is mounted on one or more axes and is capable of smoothly rolling along a surface, allowing free rotation preferably 360 degrees, while delivering a controlled ink marking to a writing surface. Microprint features 120 are preferably engraved into point 70 and may vary in depth, height, width, internal volume, size, shape, font, and other characteristics. Microprint features 120 may wrap around the surface of point 70, may appear more than once on point 70, and/or may appear in more than one direction or orientation on point 70. Point 70 may leave only an impression of microprint features 120 and may otherwise leave a written ink line that appears to be normal or typical to the naked eye.

Point 70 may be housed securely within stem 25 by means of fitting precisely into a portion of stem 25 molded and assembled for that purpose. Thus, point 70 may be attached by means of secure containment within stem 25. Stem 25 should allow enough space for movement of point 70, as well as the controlled flow of ink from ink reservoir 100 across point 70 and onto a writing surface. Stem 25 may have a spherical space comprised of curved parts, fitted together to enclose point 70, while allowing access to ink reservoir or source 100 on one side and access to the writing surface on the other.

To apply ink from a ballpoint pen to paper, point 70 is rotated by applying pressure to paper with the tip of microprint pen 300. As the microprint pens' 300 working end is rolled across a paper (or other writing surface), point 70 is rotated due to friction, and ink which clings to point 70 is drawn from ink reservoir 100 and transferred to the paper. The invention creates features 120 within the written ink line as point 70 rolls across the paper (or other writing surface), applying ink in the conventional manner, with the following unique result: ink is not applied to areas of the paper (or other writing surface) where point 70 has been engraved, leaving a negative image of microprint features 120 engraved into point 70 of the pen.

In an alternate embodiment of point 70, a positive imprint of microprint features 120 may be left if point 70 is not engraved but, rather, is molded or otherwise formed to have protruding markings within the engraving, or both methods may be utilized simultaneously on a single point. In addition, chemical, magnetic, or physical indentation methods may or may not also be utilized singly or in combination with the previously described methods.

Ink employed in the current invention may vary considerably in color, chemical composition, volume, density, viscosity, magnetism, and other physical properties. The inks disclosed in U.S. Pat. Nos. 6,613,815, 6,528,557 and 5,958,121 are incorporated by reference herein. The ink or color source may be designed to be deliverable from within ink reservoir 100 or across the point 70 and onto the paper or writing surface effectively in the conventional manner to create normal written ink line(s). However, the ink or color source must be chosen to have additional special properties. The ink or color source must cling to point 70 without in any way obscuring the unique microprint features 120 on point 70. Additionally, upon being applied to a paper or writing surface, the ink or color source must not spread or bleed such that the image left by microprint features 120 on point 70 is in any way obscured. In general, the ink must support the unique result of leaving unique, legible or otherwise clear microprint markings within the written ink line(s).

In an alternate embodiment, point 70 has microprint features 120 that protrude from point 70, rather than simply being engraved or cut out of point 70. In this embodiment, ink must again be chosen for the properties cited above, namely, the ability to cling to point 70 without obscuring microprint features 120, and the ability to be applied to a paper without obscuring microprint features 120. Ink may also be designed in such a way as to make microprint features 120 appear either noticeably lighter or darker than the rest of the inked line(s), or be visually distinguishable only through the physical imprint of microprint features 120 upon the paper. The ink or color source may only be visible under certain types of light, or by applying specially designed chemical agents, or by waiting a certain period of time for changes to occur in the ink or in a reaction of the ink with conventional or specially treated paper which would then render the ink visible or detectable. The unique microprint markings may be made by magnetically charged particles within specialized ink, drawn into a magnetized pattern, symbol, number, letter or character on the points' surface or into microprint feature 120 by a precise magnetic charge in point 70, and may thus be visible with the naked eye or using a magnetic reading device. The markings may have an option of enhanced clarity of the microprint through magnetically charged ink and components, or a process through which residual ink is removed from the engraved microprint by means of physical or magnetic displacement.

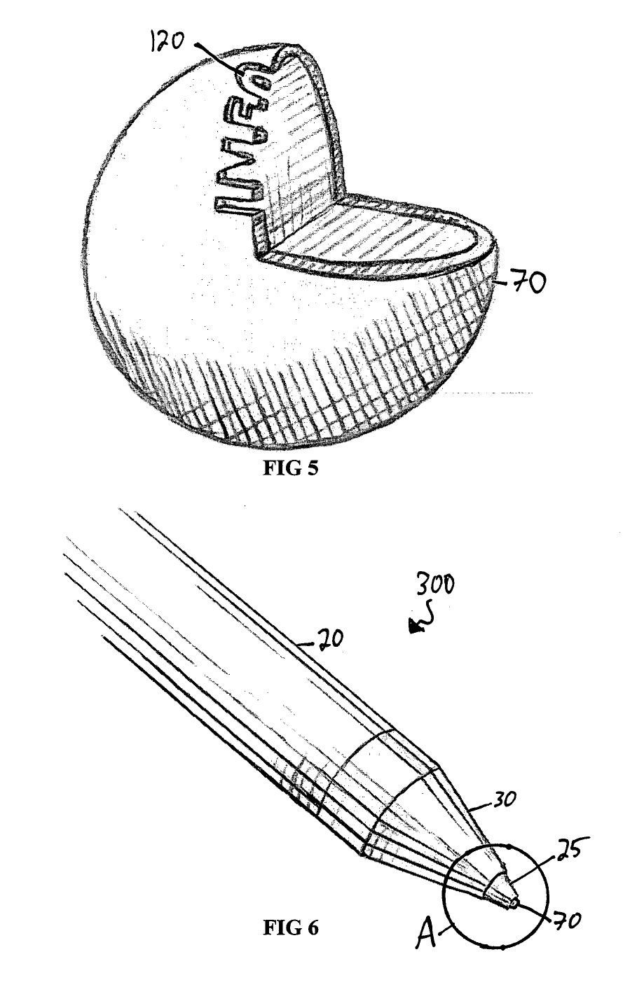

In another alternate embodiment, point 70 may be a spherical or differently shaped piece, capable of smoothly rolling along a writing surface, as shown in FIGS. 6 and 8. In this embodiment, differently shaped point 70 is mounted on one or more axes, allowing it to rotate freely, preferably 360 degrees, while delivering a controlled ink marking to a writing surface. According to this embodiment, point 70 may be a sphere, oval, or other piece capable of rolling and spinning about a central axis 75 running through a middle of point 70. The central axis 75 of point 70 may be a small pin or similar means. The pin is attached to a ring shaped piece 35 which is securely contained by stem 25, while leaving sufficient room for rotation of the ring, to allow maximum rotation of point 70, preferably in 360 degrees.

The present invention also provides a method for authenticating a written document as being unique to a particular writing instrument. Microprint pen 300 provides an efficient and logical form of document security, assuring the recipient of a written document that the origin of a document is authentic. Microprint features provide a means for a knowing recipient to verify the origin, authorship, and/or content of any text by verifying that it was written by the possessor of a particular pen.

Writing may be verified as authentic based on several characteristics. Preferably, verification is not based solely on microprinted code being discernable within every portion of a questionable written ink line. For example, should a signature's authenticity require confirmation, the written ink line will have a majority of the surface encoded with microprint in order to qualify as authentic. It must be taken into account that writing of different letters, characters, numbers and symbols have varying amounts of overlapping within a written line or single symbol or character. In these instances, the presence of microprinted code within the area of the character or characters that typically overlaps will not be considered as critical part to the authentication process, because the overlapping areas will likely have less distinguishable microprint than an area of the line not overlapping. During the verification process an additional security step may be employed by analyzing the position and/or angle of microprint features 120 of point 70. A questionable microprinted ink line may now be compared with expected values based on the position and/or angle layout of the authentic microprint record.

Additionally, if several samples of the authorized owner's handwriting are taken (signatures, etc.) using the microprint pen as the means of writing, then OCR software or a method by which the written ink line is verified may be refined by giving the areas of the text that overlap in the sample(s) less emphasis than other areas not overlapping when comparing the questionable text with the sample text. Workers skilled in the art will recognize that changes may be made in form and detail of this process. Further, it is not desired to limit the invention to the exact process and method described, and accordingly, all suitable other methods and processes of the authentication process will become obvious to the reader and it is intended that these methods and processes are within the scope of the present invention.

The invention can best be manufactured by introducing an additional step or steps to the known processes for manufacturing a conventional ballpoint pen, wherein point 70 of microprint pen 300 is engraved with unique microprint features 120. The engraving may be accomplished by means including, but not limited to, use of a laser, diamond-tipped or other highly dense cutting tools, or, alternatively, by molding point 70 with microprint features 120 already embedded in the mold. Alternatively, precision magnetizing of point 70 may be used, or the point 70 may be created using already magnetized particulates that are then molded appropriately to form microprint pattern 120 when point 70 is utilized or a smooth spherical point for use with non-engraved magnetization only verification. Point 70 may or may not be magnetically charged and may or may not have a physical engraving.

Microprint pen 300 leaves unique markings within the written ink line itself, thereby identifying the specific pen used to compose the line. If each microprint pen 300 is manufactured with its own unique microprint features 120 engraved or magnetized into point 70, anything written with that specific microprint pen 300 leaves microprint features 120 within the written ink lines. This allows a recipient to verify the authenticity of a document written with microprint pen 300. (This is contingent on the pen being assigned to and in the possession of the authorized signatory at the time of use). Additionally, any handwritten content contained in the document may be verified in the same manner, considerably limiting any possibility of fraud or deception.

In practice, point 70 of microprint pen 300 rolls over a writing surface, leaving a written line. Within the written ink line, point 70 leaves features 120 (in the standard variation, microprint negatives of the engraving), which may or may not be too small to see or notice upon casual observation of the writing with the naked eye, identifying the specific pen that was used to write. Features 120 can be seen by examining the writing with a magnifying glass, or possibly closely with a very healthy naked eye. However, features 120 may be designed such that they cannot be copied by conventional photocopiers, or by any other method, without the original microprint pen 300. These unique markings assure the recipient of a document that it was written by a particular microprint pen 300, and is not forged or reproduced.

Microprint pen 300 provides a means for heightening document security. A creator may examine writing made using the microprint pen 300 for the presence of unique microprint features 120. The features 120 may or may not be visible with close scrutiny by the healthy naked eye, or by means of a magnifying glass (which may or may not be attached to microprint pen 300), or by means of electronic character recognition, or optical character recognition, or by means of a chemical test, or magnetic reading device, or any of these used singly or in any combination. Microprint features 120 could be stored in a physical or electronic database that could be made available to consumers, corporations, organizations and/or governing bodies, or these entities may store their own databases, for the purposes of verifying a document's content containing individually assigned unique markings. This verification procedure may be used to authenticate the writing and signatures contained in official documents or contracts, including but not limited to currency, bonds, stocks, securities, travelers checks, bank checks, credit cards, credit cards receipts, passports, airline tickets, labels, green cards, prescription slips, tests and examinations, police or witness reports, affidavits, research documents, legal waivers and releases, and any other business, personal, legal and/or government document in which identification of the creator or signatory is critical. It may also be used in many unofficial applications, including but not limited to personal correspondence, journaling for posterity, archiving and scrap booking, writing for publication, autographing, or a variety of other unofficial purposes. In addition, the microprint may be used to prove date of authorship in any case in which the time of writing is an important factor, including but not limited to patent applications, checks, affidavits, and any other legally binding or non-legally binding documents. Additionally microprint pen 300 may be used simply for entertainment of its novel features.

An example of use of the microprint pen 300 as a security means is now described. A ballpoint-type microprint pen 300 has a point 70 that is engraved “JOHNSMITH01”. This microprint pen 300 is reserved for John Smith. No other person can then order a microprint pen 300 that leaves the mark “JOHNSMITH01”. John Smith now brings his pen to his local bank and signs a new signature card, and within the ink lines of his signature appears the unique negative image(s) of the characters “JOHNSMITH01” repeating several times in a random configuration. Now any forged checks can be rejected, even if the signature is very similar, because the bank clerk may now verify the security markings on the check left by the unique microprint pen 300. The bank clerk or optical character recognition and verification mechanism (O.C.R.), as described in U.S. Pat. No. 6,373,573 and incorporated herein by reference may simply view John Smith's signature card, or access the bank's electronic database; or a global microprint pen signatory database, and then examine the questionable check or document for the matching “JOHNSMITH01” microprint feature. Additionally, the amounts and other handwritten fields on the check can be verified in the same manner. Thus, the authenticity of the check's signature and/or other fields' content can by verified or disproved and a potential forgery or unauthorized check modifications can be averted.

A second example employing microprint pen 300 as a security device is shown in FIG. 12. In this example, a medical prescription written by a doctor could be verified by the pharmacy using that physician's microprint signature card, or by accessing their own or a globally maintained physical or electronic database of physician signatures with microprint 120 feature. This application could not only reduce costs associated with fraud, reduce illegal sale and distribution of prescription drugs, and save millions of people's wasted time and energy associated with calling in highly restricted prescriptions or revisiting physicians' offices, but it could also potentially save lives. By allowing quick and easy verification of prescriptions, dangerous delays in receiving vital drugs can be avoided for the millions of people who depend on prescriptions to live. In addition, potentially harmful self-medicating, recreational use, and other abuses of prescription drugs can be avoided by significantly reducing prescription fraud.

Although the present invention has been described with reference to preferred embodiments, workers skilled in the art will recognize that changes may be made in form and detail without departing from the spirit and scope of the invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the graphic and described in the specification are intended to be encompassed by the present invention.

The present invention—in its written aspect or in the microprint feature itself—may include, among other things, variations that are optical, magnetic, atomic or molecular, or biological (as in the case of DNA), in any combination or used singularly, all of which may be used as verification means.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A writing instrument for creating a unique marking comprising:
a casing having a working end and a non-working end;
an ink source situated in said casing; and
a point having microprinting means disposed on an outer surface thereof for depositing a line having a microprint embedded code formed by said microprinting means, said point being disposed at the working end of the casing, said point being a movable member arranged to rotate when moved along a surface, and said point being in fluid flow communication with said ink source.

2. The writing instrument of claim 1, wherein said microprinting means are raised above an outer surface of said point.

3. The writing instrument of claim 1, wherein said microprinting means are engraved into an outer surface of said point.

4. The writing instrument of claim 1, wherein said microprinting means are layered onto an outer surface of said point.

5. The writing instrument of claim 1, further comprising a tip for housing said point.

6. The writing instrument of claim 5, wherein said tip is coupled to said casing by a means selected from the group consisting of threading, snapping, fitting and adhesive connection.

7. The writing instrument of claim 5, wherein said tip is a conical structure.

8. The writing instrument of claim 5, wherein said tip is shaped to fit said point securely therein.

9. The writing instrument of claim 1, wherein said point is spherical.

10. The writing instrument of claim 1, wherein said point is non-spherical and said point rotates about an axis.

11. The writing instrument of claim 1, wherein said microprinting means comprises any combination of one or more markings selected from the group consisting of symbols, letters, numbers or any other distinguishable marking.

12. The writing instrument of claim 1, wherein said ink source is inserted into said casing by means of an opening disposed in the non-working end of said casing.

13. The writing instrument of claim 1, wherein said ink source is inserted into a space in said casing created by separating a first half of said casing from a second half of said casing.

14. The writing instrument of claim 1, further comprising a retraction mechanism for retracting said point.

15. The writing instrument of claim 1, further comprising a rotating mechanism for retracting said point.

16. The writing instrument of claim 1, further comprising a cap having a discerning means disposed therein.

17. A method of making a microprinted line comprising the steps of:
employing a writing instrument comprising a casing having a working end and a non-working end; an ink source situated in said casing; and a point having microprinting means disposed on an outer surface thereof for depositing a line having a microprint embedded code formed by said microprinting means, said point being disposed at the working end of the casing, said point being a movable member arranged to rotate when moved along a surface, and said point being in fluid flow communication with said ink source;
moving said point of said writing instrument across said writing surface, and
depositing a written line on said writing surface that has microprinted code formed by said microprinting means.

18. A method for authenticating a written document as being unique to a particular writing instrument comprising the steps of:
assigning a writing implement comprising a casing having a working end and a non-working end; an ink source situated in casing; and a point disposed at the working end of the casing, said point having a unique microprinting means disposed thereon to a specific creator;
having said creator employ said writing implement for writing, thereby creating a writing having a microprinted code formed therein;
inspecting said writing for said microprinted code formed by said microprinting means; and
ensuring that said microprinted code formed by said microprinting means matches said microprinting means of said assigned writing implement.

21. The method for authenticating a written document of claim 19, further comprising a step of employing discerning means for inspecting said writing for markings formed by said unique microprinting means.
